(19) United States
(12) Patent Application Publication
(10) Pub. No.: US 2025/0029977 A1
(43) Pub. Date: Jan. 23, 2025

(54) METHOD OF PROVIDING A LAMINATE

(71) Applicant: Dyson Technology Limited, Malmesbury, Wiltshire (GB)

(72) Inventor: Samuel John ALEXANDER, Gloucester (GB)

(21) Appl. No.: 18/714,400

(22) PCT Filed: Nov. 30, 2022
(86) PCT No.: PCT/GB2022/053029

§ 371 Date: May 29, 2024

(30) Foreign Application Priority Data
Dec. 2, 2021 (GB) 2117382.8

(51) Int. Cl. H01M 4/04; H01M 4/131; H01M 4/1391

(52) U.S. Cl. CPC H01M 4/0471; H01M 4/0426; H01M 4/131; H01M 4/1391

(57) ABSTRACT

Methods of providing laminates are disclosed. In examples, the method involves providing an electrode containing electrode material; providing an electrolyte on a surface of the electrode, the electrolyte containing electrolyte material; and at least one of: reducing the roughness of the surface of the electrode before providing the electrolyte on the surface of the electrode; or heating the electrolyte material to a temperature of from 100°° C. to 300° C. Also described herein are methods of reducing mechanical stress in electrolytes, methods of reducing roughness of surfaces of electrodes, methods of providing electrochemical cells, electrochemical cells, and electrically-powered devices.

### TECHNICAL FIELD

The present invention relates to methods of providing laminates, methods of reducing mechanical stress in electrolytes, methods of reducing roughness of surfaces of electrodes, methods of providing electrochemical cells, electrochemical cells, and electrically-powered devices.

### BACKGROUND

Solid-state electrochemical cells typically include at least one electrode layer contacting (e.g. abutting) a separator layer, such as an electrolyte layer. The degree to which these layers contact, e.g. the proportion of a surface of an electrode which contacts a surface of the electrolyte layer, is typically referred to as the degree of interfacial contact. The degree of interfacial contact between the electrode layer and the electrolyte layer can affect the performance of the cell. For example, reduced interfacial contact between the electrolyte layer and the electrode layer can result in shorting of the solid-state electrochemical cell, premature cell degradation, a reduced cell capacity, or increased resistance across the cell.

Interfacial contact between an electrode and an electrolyte in a secondary (e.g. re-chargeable) solid-state electrochemical cell in some cases reduces over time (e.g. the electrolyte delaminates from the electrode over time) due to cycling of the cell, which is often associated with volumetric expansion and contraction.

### SUMMARY

In examples of a first aspect of the present disclosure there is provided a method of providing a laminate comprising an electrode and an electrolyte. The method comprises: providing an electrode comprising electrode material; providing an electrolyte on a surface of the electrode, the electrolyte comprising electrolyte material; and at least one of: reducing the roughness of the surface of the electrode before the providing the electrolyte on the surface of the electrode; and heating the electrolyte material to a temperature of from 100°° C. to 300° C.

The inventors have identified that, advantageously, reducing the roughness of the surface of the electrode and/or heating the electrolyte to a temperature of from 100° C. to 300° C. results in improved performance of the electrode by, for example, improving the interfacial contact between the electrode and the electrolyte.

In examples, the process provides a laminate wherein the electrode contacts the electrolyte for at least 80%, 90%, or 95% of the area over which the electrode and electrolyte overlap. For example, the contact surface area between the electrode and the electrolyte is at least 80%, 90%, or 95% of the geometric surface areas of the electrode and electrolyte which face each other.

In some examples, interfacial contact between the electrode and the electrolyte is improved by heating at least some, or substantially all, of the electrolyte material to a temperature of from 100°° C. to 300° C. In examples, the electrolyte material is heated to a temperature of at least 125° C., or 150° C. Without wishing to be bound by theory, it is believed that heating the electrolyte material to a temperature within this range reduces mechanical stress in the electrolyte, thereby reducing the degree to which the electrolyte delaminates from the electrode over a series of charge-discharge cycles (and thus improving the interfacial contact between the electrode and the electrolyte over the lifetime of the cell). It is believed that mechanical stress in the electrolyte layer may contribute to localised disconnections, e.g. the formation of gaps, or pockets, between the electrode and the electrolyte.

The electrolyte material is typically heated to a temperature below its melting point. In examples, the electrolyte material is heated to a temperature below the temperature at which it is sintered (e.g. coalesces), such that the electrolyte material does not substantially undergo sintering during the heating.

In examples, the electrolyte material is heated to a temperature below its glass transition temperature. In particular examples, the electrolyte material is heated to a temperature within 30° C., 20° C., or 10° C. of the glass transition temperature of the electrolyte material. Without wishing to be bound by theory, it is believed that heating the electrolyte material to a temperature close to, but lower than, its glass transition temperature allows the electrolyte material to better conform to the surface of the electrode during and after its provision on the surface, thereby improving interfacial contact (and mitigating the negative effect on interfacial contact resulting from a high degree of surface roughness of the electrode). Further, again without wishing to be bound by theory, it is believed that heating the electrolyte material may serve to temper the electrolyte, thereby reducing mechanical stress in the electrolyte.

In examples, the providing the electrolyte on the surface of the electrode comprises depositing electrolyte material on the surface of the electrode, thereby providing the electrolyte. The depositing is performed according to any suitable process.

In examples, the depositing comprises physical vapour depositing. Physical vapour deposition (PVD) is an example of vacuum deposition and refers to a process wherein a condensed material is vaporised, and then at least some of the vaporised material condenses on a substrate to provide a condensed layer. Examples of PVD include thermal deposition (also referred to as evaporative deposition), and sputtering.

In examples, the depositing comprises chemical vapour depositing. Chemical vapour deposition (CVD) is an example of vacuum deposition and refers to a process wherein a substrate is exposed to one or more volatile precursors, which react and/or decompose on the substrate surface to produce a layer. Examples of CVD include low pressure chemical vapour deposition (LPCVD) and plasma enhanced chemical vapour deposition (PECVD).

In examples, the depositing comprises electrophoretic depositing. Electrophoretic deposition refers to a process wherein colloidal particles suspended in a liquid medium migrate under the influence of an electric field (electrophoresis) and are deposited onto a substrate. Examples of electrophoretic deposition include electrocoating, electrodeposition, and electrophoretic coating, and electrophoretic painting.

In examples, the depositing comprises casting. Examples of casting include spray casting, sheet casting, and spin casting. In examples, the depositing comprises screen printing.

In particular examples, the depositing the electrolyte material on the surface of the electrode comprises sputter-coating the surface of the electrode with electrolyte material, thereby providing an electrolyte at least partially contacting the surface of the electrode (e.g. contacting the electrode over at least 80%, 90%, or 95% of the surface areas of the electrode and electrolyte which overlap).

In examples, at least part or all of the electrolyte material deposited on the surface of the electrode is heated to the temperature described hereinabove for at least the duration of the providing the electrolyte on the surface of the electrode, e.g. for the duration of depositing electrolyte material on the surface of the electrode.

In examples, the providing the electrolyte on the surface of the electrode and the heating the electrolyte material are performed substantially simultaneously. For example, the heating the electrolyte material comprises heating the electrode, thereby transferring heat to the electrolyte material. The electrode is heated to a temperature of, for example, 150° C., and thermal energy is transferred from the electrode to the electrolyte material upon the electrolyte material contacting the electrode during deposition of the electrolyte material on the electrode. Thermal energy is further transferred to the electrolyte material along the thickness of the electrolyte by, for example, conduction of thermal energy through the electrolyte material. Advantageously, heating the electrolyte material in this manner reduces the requirements for further heating apparatus, e.g. a separate heater for heating the electrolyte material, because the electrode also functions as a heater for heating the electrolyte material. The electrode is heated (and thereby heats the electrolyte material) according to any suitable method. For example, the electrode functions as a resistive heater, and generates thermal energy when an electrical current is passed through it. Other heating methods are contemplated.

Alternatively, or additionally, the electrolyte material is heated after it has been deposited on the electrode, and/or before it has been deposited on the electrode. For example, the electrolyte material is heated in a chamber before it is supplied to the electrode. In these examples, the electrolyte material has a temperature of, for example, from 100°° C. to 300° C. at the point it is deposited on the surface of the electrode.

In examples the electrode is a cathode, or an anode. Where the electrode is a cathode, the electrode comprises cathode material. In examples, the cathode material comprises, consists essentially of, or consists of: lithium nickel manganese oxide (LiNi_{0.5}Mn_{1.5}O₄), typically referred to as LNMO; lithium cobalt oxide (LiCoO₂), typically referred to as LCO; lithium manganese oxide (LiMn₂O₄), typically referred to as LMO; lithium titanate (Li₄Ti₅O₁₂), typically referred to as LTO); lithium nickel manganese cobalt oxide (LiNi_{1-x-y}MnₓCo_{y}O₂), typically referred to as NMC; lithium iron phosphate (LiFePO₄), typically referred to as LFP, lithium nickel cobalt aluminium oxide (LiNi_{1-x-y}CoₓAl_{y}O₂), typically referred to as NCA; lithium sulfide (Li₂S); silver vanadium oxide (AgV₂O_{5.5}), typically referred to as SVO; or combinations thereof. In examples, the cathode is a ceramic, e.g. comprises ceramic material. In particular examples, the cathode material comprises, consists essentially of, or consists of LCO.

Where the electrode is an anode, the electrode comprises anode material. In examples, the anode material comprises, consists essentially of, or consists of: silicon, carbon, indium tin oxide (ITO), molybdenum dioxide (MoO₂), lithium titanate (Li₄Ti₅O₁₂—typically referred to as LTO), lithium alloy, metallic lithium, or combinations thereof. Where the anode comprises carbon, the anode comprises any suitable carbon-based material. For example, the anode comprises graphite, graphene, hard carbon, activated carbon, and/or carbon black. In particular examples, the anode material comprises, consists essentially of, or consists of metallic lithium.

The electrolyte comprises electrolyte material, typically ceramic material. In examples, the electrolyte material comprises, consists essentially of, or consists of: perovskite-type Li-ion conductor; anti-perovskite-type Li-ion conductor; garnet-type Li-ion conductor; sodium super ionic Li-ion conductor (NASICON); NASICON-related Li-ion conductor; lithium super ionic conductor (LISICON); LISICON-related Li-ion conductor; thio-LISICON; thio-LISICON-related Li-ion conductor; lithium phosphorous oxy-nitride (LiPON); lithium aluminium titanium phosphate (Li_{1·3}Al_{0·3}Ti_{1·7}(PO₄)₃, typically referred to as LATP); related amorphous glassy type Li-ion conductors, or combinations thereof. In particular examples, the electrolyte material comprises lithium phosphorous oxy-nitride (LiPON), the LiPON having the following formula: LiₓPO_{y}N_{z} where x=2y+3z−5, and x<4. In examples, the electrolyte comprises at least 50 wt %, 80 wt%, 90 wt %, 95 wt% or 99 wt % LiPON by dry weight of the electrolyte. In some examples, the electrolyte consists essentially of, or consists of, LiPON.

In examples, the electrode is a cathode comprising LCO, and the electrolyte comprises LiPON. In examples, the electrode is an anode comprising metallic lithium, and the electrolyte comprises LiPON.

In examples, the electrolyte is a ceramic, and the electrode (e.g. a cathode) is also a ceramic. Surprisingly, the inventors have identified that the processes described herein are particularly suitable for providing a laminate wherein a ceramic layer (e.g. cathode) abuts another ceramic layer (e.g. electrolyte) with acceptable interfacial contact between the layers.

As noted above, the electrode(s) and the electrolyte are typically provided as layers. A layer extends in a first dimension (thickness), second dimension (length), and third dimension (width). Typically, the thickness of a layer is its smallest dimension and the length of the layer is its greatest dimension, although this is not necessarily the case. In examples, the first dimension of the layers (e.g. the thicknesses) extend in the direction that the electrode and electrolyte are stacked in the laminate. “Thickness” may refer to the overall thickness of a layer, or the thickness (e.g. extent in a first dimension) of a portion of a layer.

In examples, the electrolyte has a thickness of less than 1.5 μm, or less than 1 μm. In examples, the electrolyte has a thickness greater than 0.1 μm. In examples, such as where the electrode is a cathode, the electrode has a thickness of 5 μm to 50 μm, 10 μm to 40 μm, 20 μm to 30 μm, or approximately 25 μm. In other examples, such as where the electrode is an anode, the electrode has a thickness of from 1 μm to 20 μm, or 5 μm to 15 μm.

In some examples, interfacial contact between the electrode and the electrolyte is improved by reducing the roughness of the surface of the electrode. In these examples, it is at least the surface of the electrode which is to contact (e.g. abut) the electrolyte which undergoes a reduction of surface roughness. Without wishing to be bound by theory, it is believed that reducing the roughness of the surface of the electrode allows for the electrolyte material to conform better to the surface of the electrode and/or reduce stress in the electrolyte material, thereby improving interfacial contact.

In examples, the reducing the surface roughness of the electrode comprises reducing the surface roughness to Xs, where Xs≤500 nm, or ≤100 nm. In examples, Xs is greater than or equal to 1 nm, for example greater than of equal to 5 nm.

It has been found that ensuring that the surface of the electrode is extremely smooth results in an electrode which allows for reduced likelihood of delamination between the electrode and electrolyte in use (e.g. when provided in a solid-state electrochemical cell).

With reference to the electrolyte which is provided on the electrode, the roughness of the surface of the electrode is, in examples, reduced such that Xs is no more than 20%, 10%, 5%, or 1% of the thickness of the electrolyte.

In examples, the surface roughness is measured by a profilometer. Typically, the surface roughness is measured by means of calculating the RMS roughness. The RMS roughness is calculated as the deviation in height from a perfectly smooth external surface. It will be understood that a perfectly smooth external surface is perfectly flat when the mid-plane of the substrate is transformed onto a flat plane. The surface roughness may be measured by means of calculating the arithmetic average of the absolute values of profile heights (above the minimum height measured) over an evaluation length of a sample.

In examples, the reducing the roughness of the surface of the electrode comprises heating the electrode material. For example, the heating the electrode material comprises heating the electrode material to a temperature greater than or equal to 500° C. In examples, the electrode material is heated to a temperature of at least 600° C., 700°° C., or 800° C.

The heating, in examples, comprises at least a part of a process of annealing the electrode material. For example, the heating comprises heating the material to a temperature above its recrystallization temperature, substantially maintaining the material at that temperature for a duration, then cooling the material.

In examples, the heating comprises pyrolysis of the electrode. In some examples, the pyrolysis is performed in an inert atmosphere (e.g. N₂, or argon gas). In other examples, the pyrolysis is performed in a non-inert atmosphere (e.g. in the presence of O₂).

In examples, the heating of the electrode material to a temperature greater than or equal to 500° C. is performed for a duration of from 10 minutes to 500 minutes, or 10 minutes to 300 minutes. In examples, the electrode is maintained at substantially the same temperature greater than or equal to 500° C. for a duration of from 10 minutes to 500 minutes, or 10 minutes to 300 minutes.

In examples, the electrode is a cathode, the cathode comprising cathode material. The inventors have identified that, surprisingly, heating an electrode (such as a cathode) according to the parameters set out above reduces the surface roughness of the electrode. Further, the inventors have identified that said heating may serve to reduce electrical resistance across the electrode.

In examples, the heating the electrode is performed in an air atmosphere. For example, the heating is performed in atmospheric conditions, such that the electrode is exposed to oxygen (O₂) during the heating process. Surprisingly, the inventors have identified that carrying out the heating in an oxygen-containing atmosphere decreases surface roughness and/or resistivity of the electrode, according to examples.

In examples, the reducing the roughness of the surface of the electrode comprises plasma cleaning the surface of the electrode.

For example, the electrode is provided in a treatment zone wherein plasma interacts with at least one surface of the electrode in an ablative process. Ablation of the surface allows for decreased surface roughness of the surface of the electrode prior to deposition of the electrolyte material, which can improve interfacial contact between the electrode and the electrolyte. In examples, the surface is bombarded with energetic particles, such as ions, thereby reducing roughness of the surface of the electrode.

In examples, the plasma is provided to the surface of the electrode from a plasma source, the plasma source arranged to generate plasma from a gas.

In examples, the plasma source is an inductively coupled plasma source, e.g. arranged to generate an inductively coupled plasma. The plasma source typically includes one or more antennae e.g. through which appropriate radio frequency (RF) power are driven by a radio frequency power supply system to generate an inductively coupled plasma. In examples the plasma is generated by driving a radio frequency current through the one or more antennae at a frequency between 1 MHz and 1GHz, a frequency between 1 MHz and 100 MHz, a frequency between 10 MHz and 40 MHz, or at a frequency of approximately 13.56 MHz or multiples thereof. The RF power causes ionisation of the gas to produce plasma. Tuning the RF power driven through the one or more antennae can affect the plasma density of the plasma at the surface of the electrode. Thus, by controlling the RF power at the plasma source, the process of reducing the roughness of the electrode can be controlled.

In examples, the providing the electrode comprises providing electrode material, and sintering the electrode material, thereby providing the electrode. That is, the electrode is a sintered electrode. The sintering is carried out according to any suitable method, which is known to the skilled person.

The inventors have identified that providing an electrode through sintering electrode material is typically quicker than other processes (e.g. vapour deposition) such that, advantageously, a thicker electrode can be provided in less time, and with less specialised equipment. The produced electrode, however, typically has a greater surface roughness than electrodes obtained from other processes.

The surface of the sintered electrode to which the electrolyte is to be supplied is, in examples, rolled to reduce surface roughness before supplying the electrolyte. Nevertheless, the inventors have identified that, by performing the methods described hereinabove, the rolled surface is further smoothed (e.g. the roughness decreased) before supplying the electrolyte, thereby increasing interfacial contact.

In examples, the reducing the roughness of the electrode comprises oxidising the surface of the electrode before electrolyte is provided to the surface of the electrode. The oxidising is performed by heating the electrode and/or plasma cleaning the electrode, as described hereinabove, in the presence of an oxidising agent (e.g. any material which is suitable for removing electrons from the electrode).

For example, where the electrode comprises LCO, the electrode is oxidised according to the processes described hereinabove such that substantially no Co⁰ metal is present on the surface of the electrode to which electrolyte material is to be supplied.

In examples the inventors have identified that, where the electrode (e.g. cathode) layer is provided via a sintering process, at least some of the material in the surface of the electrode is chemically reduced (e.g. adopts a lower oxidation number). For example, some sintered electrodes comprising metal oxide(s) include at least some metal in its 0oxidation state at the surface of the electrode, which can reduce the interfacial contact between the electrode and the electrolyte and/or reduce conductivity across the laminate. The inventors have further identified that, by oxidising the surface (through, for example, pyrolysis in an air atmosphere comprising O₂ or plasma cleaning comprising bombardment of the surface with ions), metal in its 0 oxidation state at the surface is oxidised to a higher oxidation state. For example, where the electrode comprises LCO, substantially any and all Co⁰ which is exposed at the surface of the electrode to which electrolyte is to be supplied is oxidised to Co(III). Surprisingly, the inventors have identified that this treatment reduces resistance across the electrode.

In examples of a second aspect of the present disclosure there is provided a method of reducing mechanical stress in an electrolyte comprising electrolyte material, the method comprising heating the electrolyte material to a temperature greater than or equal to 100° C. and less than or equal to 300°° C. Exemplary methods according to any and all of the methods of heating the electrolyte discussed hereinabove in respect of the first aspect are explicitly and independently contemplated with regard to the second aspect, to the extent that they are compatible.

In examples of a third aspect of the present disclosure there is provided a method of reducing roughness of a surface of an electrode, the electrode comprising electrode material, the method comprising heating the electrode and/or plasma cleaning the surface of the electrode. Exemplary methods according to any and all of the methods of reducing the surface roughness of an electrode discussed hereinabove in respect of the first aspect are explicitly and independently contemplated with regard to the third aspect, to the extent that they are compatible.

In examples of a fourth aspect of the present disclosure there is provided a method of providing an electrochemical cell, the method comprising performing the method according to examples described hereinabove in relation to the first aspect to provide a laminate comprising a cathode and an electrolyte; providing an anode on the electrolyte, the anode opposed to the cathode; providing a cathode current collector on the cathode, the cathode current collector opposed to the electrolyte; and providing an anode current collector on the anode, the anode current collector opposed to the electrolyte.

In examples the cathode, electrolyte, and/or anode each correspond to the cathode, electrolyte, and anode described hereinabove in relation to the first aspect.

In examples, the anode layer (e.g. metallic lithium) has a thickness of less than 20 μm, or 15 μm. The inventors have identified that, in some cases, anodes having a thickness greater than 20 μm are more prone to cracking, thereby reducing longevity of the electrochemical cell.

In examples, each current collector (the anode current collector and cathode current collector) is a metal foil (e.g. copper, tungsten, platinum, nickel, stainless steel), metal screen, metal film on a polymer film or sufficiently conductive SiO₂ layer, or any other known substrate or barrier layer.

In examples, the anode current collector is a tungsten foil, and/or the cathode current collector is a platinum foil.

Each current collector has a suitable thickness. In examples, each current collector has a thickness of from 10 nm to 10 um. In examples, the anode current collector and/or the cathode current collector have a thickness of approximately from 50 nm to 100 nm, or 50 nm, or 100 nm.

In examples of a fifth aspect of the present disclosure there is provided an electrochemical cell obtainable from the method of the fourth aspect. In examples, the electrochemical cell comprises a laminate according to the first aspect, an electrolyte according to the second aspect, and/or an electrode (e.g. a cathode) according to the third aspect.

The cell is provided in any suitable form. In examples, the electrochemical cell is a button cell. For example, the cell has a circular shape along a plane perpendicular to the layers of cathode, electrolyte, and anode forming the cell. In examples, the cell has a diameter of approximately 12 mm.

In examples of a further aspect of the present disclosure there is provided an electrically-powered device comprising the electrochemical cell described herein. An electrically-powered device is any apparatus which draws electric power from a circuit which includes the cell or battery stack, converting the electric power from the cell or battery stack to other forms of energy such as mechanical work, heat, light, and so on. In examples, the electrically-powered device is a smartphone, a cell phone, a personal digital assistant, a radio player, a music player, a video camera, a tablet computer, a laptop computer, military communications, military lighting, military imaging, a satellite, an aeroplane, a micro air vehicle, a hybrid electric vehicle, a plug-in hybrid electric vehicle, a fully electric vehicle, an electric scooter, an underwater vehicle, a boat, a ship, an electric garden tractor, an unmanned aero drone, an unmanned aeroplane, an RC car, a robotic toy, a vacuum cleaner such as a robotic vacuum cleaner, a robotic garden tool, a robotic construction utility, a robotic alert system, a robotic aging care unit, a robotic kid care unit, an electric drill, an electric mower, an electric vacuum cleaner, an electric metal working grinder, an electric heat gun, an electric press expansion tool, an electric saw or cutter, an electric sander and polisher, an electric shear and nibbler, an electric router, an electric tooth brush, an electric hair dryer, an electric hand dryer, a global positioning system (GPS) device, a laser rangefinder, a torch (flashlight), an electric street lighting, a standby power supply, uninterrupted power supplies, or another portable or stationary electronic device.

As noted above, features described herein in relation to one aspect of the present disclosure are explicitly disclosed in combination with the other aspects, to the extent that they are compatible.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a flow chart of a method of reducing mechanical stress in an electrolyte comprising electrolyte material.

FIG. 2 is a flow chart of a method of reducing roughness of a surface of an electrode.

FIG. 3 is a flow chart of a method of providing a laminate according to examples.

FIG. 4 is a schematic diagram of a cross-section of a laminate according to examples.

FIG. 5 is a flow chart of a method of providing a solid-state electrochemical cell according to examples.

FIG. 6 is a schematic diagram of a cross-section of a solid-state electrochemical cell according to examples.

FIG. 7 is a schematic diagram of an electrically-powered device according to examples.

### DETAILED DESCRIPTION

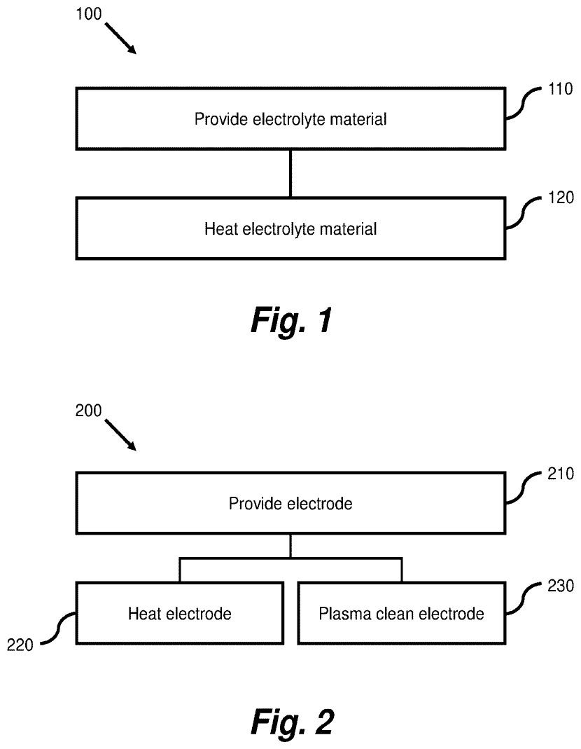

FIG. 1 is a flow chart of a method 100 of reducing mechanical stress in an electrolyte comprising electrolyte material.

The method 100 comprises providing 110 electrolyte material. In this example, the providing 110 electrolyte material comprises depositing electrolyte material on a substrate by sputter-coating at least a portion of the substrate. The substrate in this example is a cathode, such that the providing 110 electrolyte material comprises sputter-coating at least a portion of a surface of the cathode with electrolyte material.

The method 100 further comprises heating 120 the electrolyte material to a temperature of at least 150° C., thereby reducing mechanical stress in the electrolyte material. In this example, the heating 120 the electrolyte material comprises heating the cathode on which the electrolyte material is deposited, thereby heating the electrolyte material through transfer of thermal energy from the cathode to the electrolyte material. The electrode is heated for at least a portion of, or for the entire, duration of depositing the electrolyte material on the surface of the cathode.

FIG. 2 is a flow chart of a method 200 of reducing roughness of a surface of an electrode. The method 200 comprises providing 210 an electrode. In this example, electrode is a cathode, and the providing 210 comprises depositing cathode material on a substrate (e.g. silicon wafer), and sintering the cathode material to provide a sintered cathode.

In one example of the method 200 depicted in FIG. 2, the method 200 further comprises heating 220 the electrode (which in this example is a cathode), thereby reducing the roughness of a surface of the electrode. In this example, the heating 220 comprises heating the cathode to a temperature of 500° C. for a duration of 300 minutes. In this example, the heating 220 at least partially anneals the cathode, and oxidises at least part of a surface of the cathode (such that substantially no metallic element in its 0 oxidation state is present at the portion of the surface of the cathode).

Alternatively, or additionally, the method 200 comprises plasma cleaning 230 a surface of the electrode, thereby reducing the roughness of a surface of the electrode. In this example, the plasma cleaning 230 comprises bombarding the surface with ions in an ablative process.

The surface where the roughness has been reduced during the heating 220 and/or the plasma cleaning 230 is for receiving an electrolyte in the preparation of a laminate or solid-state electrochemical cell.

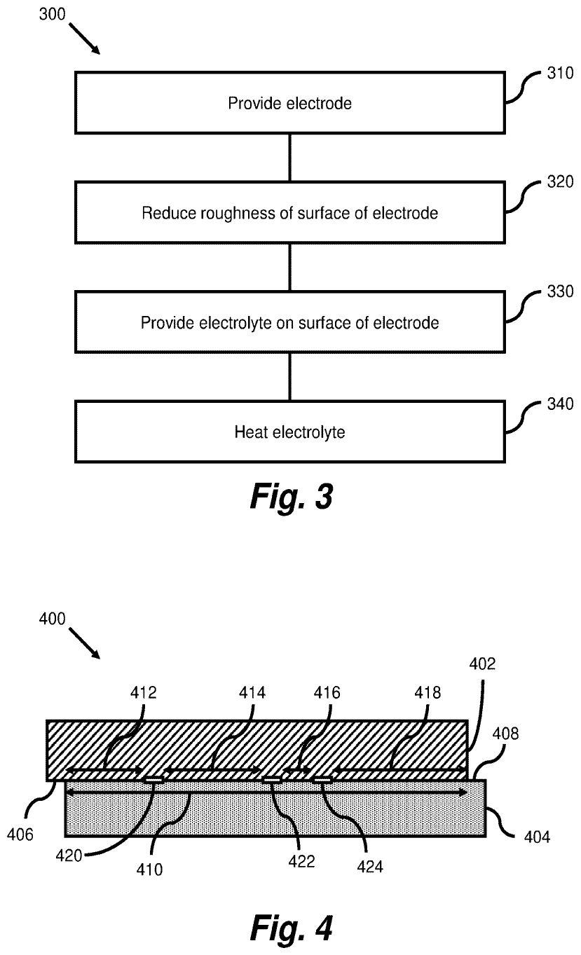

FIG. 3 is a flow chart of a method 300 of providing a laminate according to examples. The method 300 comprises providing 310 an electrode, and reducing 320 a surface of the electrode. In this example, the providing 310 and reducing surface roughness 320 correspond respectively to the providing 210 an electrode and heating 220 and/or the plasma cleaning 230 the electrode depicted in FIG. 2.

The method 300 further comprises providing 330 an electrolyte on the surface of the electrode, and heating 340 the electrolyte. The providing 330 and heating 340 correspond respectively to the providing 110 and heating 120 depicted in FIG. 2. In the method 300 depicted in FIG. 3, the providing 330 the electrolyte comprises depositing electrolyte material on the at least one surface of the electrode which has undergone a roughness-reduction process.

FIG. 4 is a schematic diagram of a cross-section of a laminate 400 according to examples. The laminate 400 comprises an electrode 402 and an electrolyte 404. In this example, the electrode 402 is a cathode and comprises LCO, and the electrolyte 404 comprises LiPON.

The electrode 402 comprises a surface 406 facing a surface 408 of the electrolyte 404. For at least a portion of the electrode surface 406 and the electrolyte surface 408, the electrode 402 and electrolyte 404 overlap. This degree of overlap between the electrode 402 and the electrolyte 404, i.e. the geometric surface areas of the electrode 402 and electrolyte 404 which face each other, is indicated by an arrow 410.

At least part of the electrode surface 406 contacts the electrolyte surface 408 along the overlapping geometric surface areas 410 of the electrode 402 and electrolyte 404, along contact portions 412, 414, 416, 418. In this example, the laminate 400 includes a plurality of localised disconnections 420, 422, 424. That is, in some places, a portion of the electrode surface 406 and a corresponding portion of electrolyte surface 408 facing the portion of electrode surface 406 are arranged apart, e.g. separated by a gap. Nevertheless, in this example, the localised disconnections 420, 422, 424 account for less than 5% of the overlapping geometric surface areas 410 of the electrode 402 and electrolyte 404. That is, taken together, the contact portions 412, 414, 416, 418 between the electrode 402 and the electrolyte 404 account for at least 95% of the overlapping geometric surface areas 410, such that the interfacial contact between the electrode 402 and electrolyte 404 is at least 95% of the overlapping geometric surface areas.

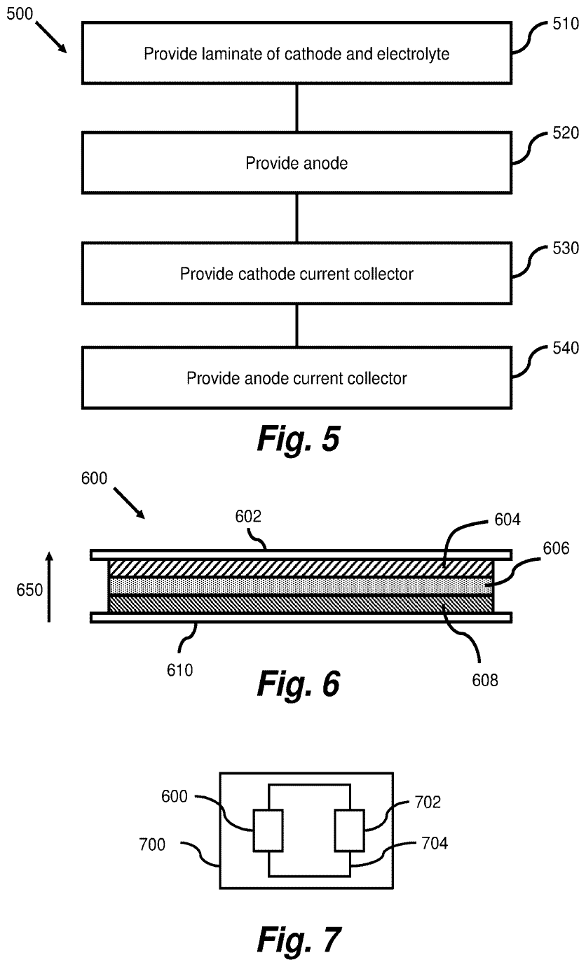

FIG. 5 is a flow chart of a method 500 of providing a solid-state electrochemical cell according to examples. The method 500 comprises providing 510 a laminate of cathode and electrolyte according to the method 300 depicted in FIG. 3.

The method 500 further comprises providing 520 an anode on the electrolyte of the cathode-electrolyte laminate. In this example, the providing 520 the anode comprises depositing anode material on the electrolyte of the cathode-electrolyte laminate, thereby sandwiching the electrolyte between the cathode and the anode. The anode material comprises metallic lithium (i.e. lithium metal).

The method 500 further comprises providing 530 a cathode current collector on the cathode. The cathode current collector is provided on a surface of the cathode opposed to the electrolyte, thereby sandwiching the cathode between the cathode current collector and the electrolyte. The cathode current collector in this example is platinum foil.

The method 500 further comprises providing 540 an anode current collector on the anode. The anode current collector is provided on a surface of the anode opposed to the electrolyte, thereby sandwiching the anode between the anode current collector and the electrolyte. The anode current collector in this example is tungsten foil.

FIG. 6 is a schematic diagram of a cross-section of a solid-state electrochemical cell 600 according to examples. The cell 600 comprises a cathode current collector 602. The cathode current collector 602 is platinum foil, and has a thickness (i.e. its extent along the direction indicated by the arrow 650) of approximately 100 nm.

The cathode current collector 602 contacts a cathode 604. The cathode 604 comprises is a sintered LCO cathode, and has a thickness of approximately 25 μm.

The cathode 604 contacts an electrolyte 606 on a surface of the cathode 604 opposed to the cathode current collector 602. The electrolyte 606 comprises LiPON, and has a thickness of approximately 1.5 μm.

The electrolyte 606 contacts an anode 608 on a surface of the electrolyte 606 opposed to the cathode 604. The anode comprises lithium metal, and has a thickness of approximately 9 μm.

The anode 608 contacts an anode current collector 610 on a surface of the anode 608 opposed to the electrolyte 66. The anode current collector 610 comprises tungsten foil, and has a thickness of approximately 100 nm.

FIG. 7 is a schematic diagram of an electrically-powered device 700 according to examples. The electrically-powered device 700 comprises the solid-state electrochemical cell 600 depicted in FIG. 6. In examples (not shown), the solid-state electrochemical cell 600 is provided as part of a battery stack, the battery stack comprising a plurality of solid-state electrochemical cells electrically connected together.

The electrically-powered device comprises an element 702 which converts electric power from the solid-state electrochemical cell 600 to another form of energy (e.g. mechanical work, heat, light, and so on). The solid-state electrochemical cell 600 and element 702 are connected by one or more electrical conduits 704 which, in examples, forms an electrical circuit.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of providing a laminate comprising an electrode and an electrolyte, the method comprising:
providing an electrode comprising electrode material;
providing an electrolyte on a surface of the electrode, the electrolyte comprising electrolyte material; and
at least one of:
reducing the roughness of the surface of the electrode before the providing the electrolyte on the surface of the electrode; or
heating the electrolyte material to a temperature of from 100° C. to 300° C.

2. The method of claim 1, wherein the providing the electrolyte on the surface of the electrode and the heating the electrolyte material are performed substantially simultaneously.

3. The method of claim 1, wherein the heating the electrolyte material comprises heating the electrode, thereby transferring heat to the electrolyte material.

4. The method of claim 1, wherein the heating the electrolyte material comprises heating the electrolyte material to a temperature less than a glass transition temperature of the electrolyte material.

5. The method of claim 1, wherein the reducing the roughness of the surface of the electrode comprises heating the electrode material and/or plasma cleaning the surface of the electrode.

6. The method of claim 5, wherein the heating the electrode material comprises heating the electrode material to a temperature greater than or equal to 500° C., thereby annealing the electrode material.

7. The method of claim 6, wherein the heating the electrode material to a temperature greater than or equal to 500° C. is performed for a duration of from 10 minutes to 300 minutes.

8. The method of claim 5, wherein the heating the electrode material is performed in an air atmosphere.

9. The method of claim 1, wherein the providing the electrode comprises:
depositing electrode material; and
sintering the electrode material, thereby providing the electrode.

10. The method of claim 1, wherein the electrolyte material comprises ceramic material.

11. The method of claim 1, wherein the electrolyte material comprises lithium phosphorous oxy-nitride (LiPON).

12. The method of claim 1, wherein the electrode material comprises lithium cobalt oxide (LiCoO₂).

13. A method of reducing mechanical stress in an electrolyte comprising electrolyte material, the method comprising heating the electrolyte material to a temperature greater than or equal to 100° C. and less than or equal to 300° C.

14. A method of reducing roughness of a surface of an electrode, the electrode comprising electrode material, the method comprising heating the electrode and/or plasma cleaning the surface of the electrode.

15. A method of providing an electrochemical cell, the method comprising:
performing the method according to claim 1 to provide a laminate comprising a cathode and an electrolyte;
providing an anode on the electrolyte, the anode opposed to the cathode;
providing a cathode current collector on the cathode, the cathode current collector opposed to the electrolyte; and
providing an anode current collector on the anode, the anode current collector opposed to the electrolyte.

16. An electrochemical cell obtainable from the method of claim 15.

17. An electrically-powered device comprising the electrochemical cell of claim 16.
